(19) United States
(12) Patent Application Publication
(10) Pub. No.: US 2004/0118762 A1
(43) Pub. Date: Jun. 24, 2004

(54) Packing materials for liquid chromatography using chemically modified diamond powders

(76) Inventors: Jishou Xu, Bloomington, IN (US); Edmond Bowden, Raleigh, NC (US)

Correspondence Address: JUSHOU XU, 15 HEARTHSTONE, IRVINE, CA, 92606, US

(21) Appl. No.: 10/322,863

(22) Filed: Dec. 18, 2002

(51) Int. Cl. B01D 15/08

(52) U.S. Cl. 210/198.2; 502/401

(57) ABSTRACT

Packing materials useful in applications such as liquid chromatography and solid phase extraction, as well as processes for producing such packing materials are described. The packing materials are based on chemically modified diamond powders. The surfaces of the diamond powders are attached with hydrocarbon, amino, carboxylic acid, or sulfonic acid groups through C—C, C—N, or C—S single bonds. The residual groups can be solely hydroxyl groups or solely hydrogen atoms. The stability of the packing materials allows regeneration of columns at pH>14 for protein separation. With hydrogen atoms as the residual groups for reverse phase diamond packings, the non-specific interaction associated with silica, polymeric, or graphitic packings can be largely eliminated. With hydroxyl groups as the residual groups for ion exchangers based on diamond powders, the non-specific interaction associated with hydrophobic sites can be largely eliminated.

The present invention relates to packing materials useful in applications such as separation, purification and extraction of proteins, peptides, etc., as well as processes for producing such packing materials. The packing materials will have extremely high stability and little non-specific interaction.

### BACKGROUND OF THE INVENTION

In the field of liquid chromatography (LC), there has been continuous demand for packing materials with high chemical stability and little nonspecific interaction. Packing materials with high chemical stability and little non-specific interaction are specifically precious for LC of proteins. First, LC of proteins suffers more from the non-specific interaction than LC of small molecules. Non-specific interaction leads to severe peak tailing or even low recovery for protein separation. Second, protein samples often foul LC columns because some protein components are irreversibly retained. The proteins retained on LC columns are difficult to be flushed away by merely adjusting the hydrophobicity of the flush solution. Cleaning under high pH is an efficient way to flush away various proteins but at the risk of damaging LC columns. If a column is stable at pH>14, flushing the fouled column at pH>14 will decompose retained proteins into amino acids and the foulants will then be rinsed away readily.

Porous stationary packing materials are generally preferred to non-porous stationary packing materials in LC of small molecules. Non-porous packing materials have adsorption capacities lower than the porous sorbents. On the other hand, non-porous packing materials have shorter diffusion paths, which minimizes the peak broadening by mass transfer resistance. Non-porous particles have gained increasing interest for LC of proteins. Particles designed for LC of proteins often have large pore sizes. For a particle with large pore size, the loading capacity has been found to be only a few times higher than that of equally sized non-porous packing materials. At the same time, the improvement of column efficiency of non-porous particles becomes much more significant for the separation of proteins. For large molecules, non-porous packing materials exhibit fast mass transport as restricted pore diffusion is eliminated and peak broadening is significantly minimized.

Packing materials are best with spherical shape and with uniform distribution of size. Imperfections of particle shape and size distribution are more tolerable in HPLC of proteins because gradient elution is always applied. Imperfections of particle shape and size distribution are not much detrimental for packing materials used in solid phase extraction, zip-tipping, and the first dimension LC in two-dimensional LC.

### DESCRIPTION OF THE PRIOR ART

The commonest packing material for LC has been chemically modified silica powders. Silica columns suffer from low stability under high pH and nonspecific interaction. The low stability of silica packing materials is due to the dissolution of silica and the hydrolysis of the surface bonds between the surface capping and silica. For reverse phase silica, non-specific interaction arises from residual surface hydroxyl groups. Silica surfaces are stably capped by hydroxyl groups, which are hydrophilic and negatively charged at pH>4. A complete replacement of hydroxyl groups on silica surfaces by hydrophobic hydrocarbon groups is impossible because of steric hinderance. There will be no steric hinderance to prevent a complete replacement of hydroxyl groups by hydrogen, which is hydrophobic, but hydrogen capping on silica is not stably.

Graphitic packings and polymeric packings can be much more stable than silica packing materials. The bulk of graphite and many polymers is stable under a broad range of pH. The surface bonds for graphitic packings and polymeric packings (e.g., C—C bonds) can be also stable under a broad range of pH.

Unfortunately, graphitic packings and polymeric packings often suffer from non-specific interaction more than silica packings. There are an undefined amount of basal plane sites on graphitic surfaces, which can not be chemically derivatized directly. Strong non-specific interaction resulted from basal plane sites has been evidenced in graphitic packings. The conjugated π-electrons contribute to the surface interaction at graphitic surfaces. For polymeric packings, the non-specific interaction is due to the facts that: i) polymeric packing materials usually contain aromatic structures; and ii) polymers are usually neither fully dense nor rigid at molecular scales. The organic matrix (specifically aromatic components) of polymers participates in non-specific interaction. Polymeric solids contain some voids with sizes ranging from atomic scales to nano-scales. The adsorption at polymer is a combination of surface process and “hole filling” process. Polymeric surfaces are not rigid or immobile as the surfaces on atomic or ionic crystals. Surface dynamics permit the polymeric lattice to reconstruct in response to the adsorbates. Such surface dynamics are an important factor to promote adsorption at polymeric surfaces.

The preparation of diamond powders with sizes from 200 nanometers to 100 micrometers has been relatively cheap and large volume technology. Unmodified diamond powders have been used as packing material for HPLC. Unmodified diamond powders both occurred naturally and manufactured are capped with a mixture of hydrogen, which is hydrophobic, and oxygen functionalities, many of which are hydrophilic or charged. Hence, the unmodified diamond powders are not of high quality neither as normal phase packing materials nor as reverse phase packing materials. It is necessary to chemically modify diamond powders to make them capped with the desired capping. To minimize non-specific interaction, the residual groups on diamond surfaces should be well controlled, too. Diamond surfaces can be stably capped by both hydrogen and hydroxyl. A totally hydrophobic diamond surface can be prepared with hydrophobic hydrogen atoms as residual groups, and a totally hydrophilic diamond surface can be prepared with hydrophilic hydroxyl groups as residual groups.

Recent studies on the surface chemistry of diamond have shown that diamond surfaces are chemically modifiable. First, chemically, diamond is a giant polycyclic aliphatic molecule and the diamond surface is composed of organic functionalities, for which an enormous database of methods and mechanisms has been established. The chemical composition of diamond surfaces can be finely controlled through organic reactions. Second, because of the chemical inertness of the bulk of diamond (i.e., tetrahedral C—C bonds), even surface functionalities with low reactivity (e.g., tetrahedral C—H bonds) can be modified under violent conditions with little damage to the bulk of diamond. Diamond surfaces were hydrogenated by hydrogen plasma or under temperatures>800 Celsius degree. Halogenation of diamond surfaces has been carried out with plasma and under UV radiation. Chlorinated diamond surfaces are active in reactions with water, ammonia, etc. Organic groups have been attached onto halogenated diamond surfaces through stable surface bonds (e.g., C—N and C—C single bonds). Organic groups can also be attached onto diamond surfaces through C—C surface bonds by cycloaddition reactions. The organic groups attached onto diamond surfaces can be further modified under various conditions with little damage to the bulk of diamond.

### BRIEF DESCRIPTION OF THE INVENTION

The present invention sets forth methods to prepare packing materials with extremely high stability and little non-specific interaction. The packing materials are based on chemically modified diamond powders. The chemical modification will control the surface chemistry of diamond powders. The diamond powders will be attached with organic groups through C—C or C—N single bonds. For reverse phase packing materials, the residual groups will be hydrophobic hydrogen atoms; for normal phase packing materials and ion exchangers, the residual groups will be hydrophilic hydroxyl groups.

For the packing materials based on chemically modified diamond powders, there will not be any chemical degradation arising from the bulk of diamond or the surface bonds between diamond and the organic groups under any condition that is applied for LC. As long as the organic groups capped on the diamond surfaces are stable, the chemically modified diamond powders will be stable in any basic solutions, which allows regeneration and cleaning procedures for LC columns at pH>14. In LC of proteins, LC columns are often fouled by protein components irreversibly retained. The retained protein components are difficult to be flushed away by merely adjusting the hydrophobicity of the flush solution. Flushing the fouled columns at pH>14 will decompose retained proteins into amino acids and the foulants will then be rinsed away readily.

For the packing materials based on chemically modified diamond powders, the non-specific interaction is largely eliminated. For reverse phase LC, the non-specific interaction arising from surface hydroxyl groups can be eliminated. A totally hydrophobic diamond surface can be prepared with hydrophobic hydrogen capping as residual groups. Also, hydroxyl groups on diamond surfaces will not be deprotonated in aqueous solution as silanols. Diamond is fully dense and rigid at the atomic scale. Diamond packings are free of the non-specific interaction associated with polymeric packings. Diamond is isotropic. The surface sites at different crystal faces and defect sites on diamond surfaces are all active to coupling reactions. Diamond is composed of tetrahedral carbon. Diamond packings will be free of the non-specific interaction associated with graphitic packings. For diamond packings in ion exchange chromatography, the residual groups will be hydroxyl groups to avoid the non-specific interaction arising from hydrophobic surface sites.

The packing materials based on chemically modified diamond powders can be also used in solid phase extraction, zip-tipping, and the first dimension LC for two-dimensional LC. For these applications, packing materials based on chemically modified diamond powders will have their advantages in stability, anti-fouling ability, de-fouling capability, and high recovery without the disadvantages resulted from the imperfections of particle shape and size distribution.

### SUMMARY OF THE INVENTION

Exemplary processes for the preparation of packing materials based on chemically modified diamond powders will now be discussed. The process begins with diamond powders that are commercially available, whose surfaces are typically capped by a mixture of hydrogen and oxygen functionalities. Diamond powders comprise diamond powders that occur naturally in nature and diamond powders that are manufactured. The number of diamond powders is not limited. The size of diamond powders can be, for example, but not limited to, 1-50 micrometers.

STEP 1: Pretreatment: Hydrogenation of Diamond Powders

The diamond powders will be hydrogenated to remove the surface oxygen functionalities. The hydrogenation step comprises heating the diamond powders in a hydrogen atmosphere at elevated temperature. The temperature can be, for example, but not limited to, 700-900 Celsius degrees. The hydrogen atmosphere can contain hydrogen with one or more inert gases. The inert gas can be, for example, but not limited to, helium. The hydrogen atmosphere can be continuously flowing through the reactor during the hydrogenation process. After the hydrogenation process, the diamond powders will be cooled down to room temperature in the hydrogen atmosphere.

The hydrogenation step is alternatively performed by subjecting diamond powders to hydrogen plasma.

STEP 2: Pretreatment: Halogenation of Diamond Powders

The hydrogenated diamond powders produced in STEP 1 or as-received diamond powders will be halogenated. The halogenation process can be performed with, for example, but not limited to, chlorine. The halogen atmosphere for halogenation can contain the halogen with an inert gas. The inert gas can be, for example, but not limited to, helium. The halogenation process can be activated by, for example, but not limited to, UV light, plasma, or heating. The temperature for halogenation can be, for example, but not limited to, 200 to 400 Celsius degree. The halogen atmosphere can be continuously flowing through the reactor. At the end of the halogenation process, the reactor will be cooled down to room temperature with the halogen atmosphere. The reactor will be then purged with a gas atmosphere containing only inert gas. The halogenated diamond powders will be kept away from moisture.

STEP 3: Pretreatment: Preparation of Clean Diamond Surface

Diamond powders will be pretreated to produce surface sites that will undergo cycloaddition reactions. The non-carbon atoms on diamond surface will be partially or fully desorbed. The diamond powders can be as-received diamond powders or hydrogenated diamond powders produced by STEP 1. The pretreatment of diamond powders can be, for example, but not limited to, heating the diamond powders under high temperatures. The temperature can be about, for example, but not limited to, 1000 Celsius degrees. The pretreatment will be performed in vacuum or in an inert gas. The inert gas can be, for example, but not limited to, helium. The pretreatment desorbs some or all non-carbon atoms on the diamond surface. The reactor will be cooled down to room temperature with the reactor being flown with the inert gas or being kept in vacuum.

The desorption of surface hydrogen atoms on hydrogenated diamond powders is alternatively performed with the presence of a catalytic gas. The catalytic gas can be, for example, but not limited to, chlorine. The gas atmosphere can contain the catalytic gas with an inert gas. The inert gas can be, for example, but not limited to, helium. The catalytic gas will react with surface C—H bonds and the hydrogen atoms on diamond surfaces are abstracted away. The temperature can be at, for example, but not limited to, 500 Celsius degree. Alternatively, the temperature can be cycling between 200 and 500 Celsius degree. The gas atmosphere can be continuously flowing through the reactor. At the end of the process, the reactor will be purged with a gas atmosphere containing only the inert gas at about 500 Celsius degree. The atoms of the catalytic gas will not be attached onto the diamond surface because the diamond surface terminated by the atoms of the catalytic gas is unstable at about 500 Celsius degrees. The reactor will be cooled down to room temperature with a gas atmosphere containing only the inert gas.

STEP 4: Diamond Powders Capped with Hydroxyl Groups

The as-received diamond powders or hydrogenated diamond powders will be performed with halogenation followed by hydrolysis. The halogenation will be performed as in STEP 2. The halogenated diamond powders will be hydrolyzed with a basic solution. pH of the hydrolysis solution can be adjusted with, for example, but not limited to, sodium bicarbonate or sodium hydroxide. After the hydrolysis process, hydroxyl groups are attached onto the surfaces of the diamond powders. To transform more surface hydrogen into surface hydroxyl, these diamond powders can be performed with two or more cycles of halogenation followed by hydrolysis.

The diamond powders will then be reduced with lithium aluminum hydride. The lithium aluminum hydride will be initially dissolved in tetrahydrofuran. Surface oxygen functionalites other than hydroxyl will be reduced to hydroxyl by lithium aluminum hydride.

STEP 5A: Diamond Powders Capped with Hydrocarbon Groups and with Hydrogen as the Residual Groups

The as-received diamond powders will be hydrogenated by STEP 1 and then halogenated by STEP 2. The halogenated diamond powders will react with a chemical agent to attach hydrocarbon groups onto diamond surfaces through C—C single bonds. The chemical agent can be, for example, but not limited to, lithium salts of hydrocarbon groups or Grignard reagents in an inert organic solvent. The organic solvent can be, for example, but not limited to, tetrahydrofuran or hexane. The diamond powders will then be reacted with a reducing agent. The reducing agent will be initially dissolved in tetrahydrofuran. The reducing agent can be, for example, but not limited to lithium aluminum hydride. The reducing agent will replace the residual halogen atoms on diamond surfaces with hydrogen atoms. The diamond powders will be continuously blanketed by an inert gas and kept away from moisture during the process.

STEP 5B: Diamond Powders Capped with Hydrocarbon Groups and with Hydrogen as the Residual Groups

The hydrocarbon groups are attached onto diamond surfaces by cycloaddition reactions through C—C single bonds. The diamond powders produced by STEP 3 are exposed to a chemical agent for cycloaddition reactions. The chemical agent is hydrocarbon compounds containing functionalities that can undergo cycloaddition reactions with the diamond powders produced in STEP 3. The functionalities can be, for example, but not limited to, diene group. The chemical agent can be in a state of, for example, but not limited to, pure liquid or solution in an inert solvent. The inert solvent can be, for example, but not limited to, hexane or cyclohexane.

After the cycloaddition reactions, the diamond powders will be hydrogenated. First, the diamond powders will be performed with a addition reaction with a chemical agent. The chemical agent for the addition reaction can be, for example, but not limited to, HCl gas. The addition reaction will occur with the dangling bonds on diamond surfaces and the C—C double bonds in the hydrocarbon groups. The gas atmosphere can contain the chemical agent for the addition reaction with one or more inert gases. The inert gas can be, for example, but not limited to, helium. The gas atmosphere can be continuously flowing through the reactor during the addition reaction. Alternatively, the chemical agent for the addition reaction is dissolved in a organic solvent. Second, the diamond powders will then be reacted with a reducing agent. The reducing agent will be initially dissolved in tetrahydrofuran. The reducing agent can be, for example, but not limited to lithium aluminum hydride. The reducing agent will replace the residual halogen atoms on diamond surfaces with hydrogen atoms. The diamond powders will be continuously blanketed by an inert gas and kept away from moisture during the process.

STEP 6: Cation Exchanger with Hydroxyl as the Residual Groups

The as-received diamond powders will be hydrogenated by STEP 1 and then halogenated by STEP 2. The halogenated diamond powders will react with a chemical agent to attach hydrocarbon groups through C—C single bonds. The hydrocarbon groups in the chemical agent contain one or more C—C double or triple bonds. The chemical agent can be, for example, but not limited to, sodium acetylide, lithium salt of hydrocarbon compounds, or Grignard reagents in an inert organic solvent. The inert solvent can be, for example, but not limited to, hexane or tetrahydrofuran. The residual halogen atoms on diamond surfaces will be transformed into hydroxyl groups by hydrolysis. pH of the hydrolysis solution can be adjusted with, for example, but not limited to, sodium bicarbonate or sodium hydroxide. The C—C double or triple bonds will be reacted with an oxidizing agent to form carboxylic groups on diamond surfaces. The oxidizing agent can be, for example, but not limited to, potassium permanganate. The diamond powders will be then reacted with a reducing agent to transform ketone structures into hydroxyl groups. The reducing agent can be, for example, but not limited to sodium borohydride.

Alternatively, diamond powders are attached with hydrocarbon groups through C—C bonds. The diamond powders will be then halogenated followed by hydrolysis. The primary alcohol structures will be reacted with an oxidizing agent to form carboxylic groups on diamond surfaces. The oxidizing agent can be, for example, but not limited to, potassium permanganate.

Alternatively, diamond powders are attached with hydrocarbon groups through C—C bonds. The diamond powders can be treated with, for example, but not limited to, sulfuric acid or chlorosulfuric acid. Sulfonic acid groups will be attached to the surfaces of the diamond powders directly or to the hydrocarbon groups, which are attached on the surfaces of the diamond powders through C—C bonds.

STEP 7: Anion Exchanger with Hydroxyl as the Residual Groups

The as-received diamond powders will be hydrogenated by STEP 1 and then halogenated by STEP 2. The halogenated diamond powders produced by STEP 2 are treated with ammonia or sodium amide. The diamond powders will be fully or partially capped with amino groups. The residual halogen atoms on diamond surfaces will be transformed into hydroxyl groups by hydrolysis in a basic solution. pH of the hydrolysis solution can be adjusted with, for example, but not limited to, sodium bicarbonate or sodium hydroxide. The diamond powders will be then reacted with a reducing agent to transform ketone or aldehyde structures into hydroxyl groups. The reducing agent can be, for example, but not limited to sodium borohydride. The amino groups can be further treated with methyl iodide, which will transform the primary amino groups into quaternary amino groups.

Alternatively, the diamond powders are partially or fully capped with hydrocarbon groups by STEP 5. The diamond powders will be halogenated by STEP 2 and then treated with ammonia or sodium amide. The diamond powders will be fully or partially capped with amino groups. Amino groups can be attached directly on diamond surfaces or on the hydrocarbon groups.

Alternatively, the halogenated diamond powders are treated with trimethyl amines. Trimethyl amino groups will be attached to the surfaces of the diamond powders or to the hydrocarbon groups, which are attached on the surfaces of the diamond powders through C—N bonds.

STEP 8: Fluorinated Diamond Powders

The hydrogenated diamond powders will be reacted to a fluorinating agent. The fluorinating agent can be, for example, but not limited to, fluorine gas.

We claim:

1: A Packing material for liquid chromatography and solid phase extraction comprising chemically modified diamond powders

2: A packing material for liquid chromatography and solid phase extraction as claimed in claim 1 wherein the surfaces of the diamond powders are fully terminated with hydroxyl groups

3: A packing material for liquid chromatography and solid phase extraction as claimed in claim 1 wherein the surfaces of the diamond powders are attached with hydrocarbon groups through C—C single bonds and the residual groups are hydrogen atoms

4: A packing material for liquid chromatography and solid phase extraction as claimed in claim 1 wherein the surfaces of the diamond powders are terminated solely with hydrogen atoms

5: A packing material for liquid chromatography and solid phase extraction as claimed in claim 1 wherein carboxylic groups are attached to the surfaces of the diamond powders directly or to hydrocarbon groups, which are attached on the surfaces of the diamond powders through C—C bonds, and some or all residual groups are hydroxyl groups

6: A packing material for liquid chromatography and solid phase extraction as claimed in claim 1 wherein sulfonic acid groups are attached to the surfaces of the diamond powders directly or to hydrocarbon groups, which are attached on the surfaces of the diamond powders through C—C bonds, and some or all residual groups are hydroxyl groups

7: A packing material for liquid chromatography and solid phase extraction as claimed in claim 1 wherein amino groups or alkylated amino groups are attached to the surfaces of the diamond powders directly or to hydrocarbon groups, which are attached on the surfaces of the diamond powders through C—C bonds, and some or all residual groups are hydroxyl groups

8: A packing material for liquid chromatography and solid phase extraction as claimed in claim 1 wherein the surfaces of the diamond powders are terminated with fluorine atoms.

9: A method for preparing hydrophilic diamond powders, comprising the steps of, in sequence,
i) reacting the diamond powders with a halogenating agent, thereby replacing hydrogen atoms on the surfaces of the diamond powders with halogen atoms
ii) reacting the diamond powders with a basic aqueous solution, thereby replacing the halogen atoms on the diamond powders with hydroxyl groups
iii) repeating procedure (i) and (ii) for one or more times
iv) reacting the diamond powders with a reducing agent, thereby transforming the oxygen functionalities other than hydroxyl on the surfaces of the diamond powders into hydroxyl groups

10: A method for preparing hydrophobic diamond powders, comprising the steps of, in sequence,
i) reacting halogenated diamond powders with a organometallic compound, thereby attaching hydrocarbon groups on the surfaces of the diamond powders through C—C bonds
ii) reacting the diamond powders with a reducing agent, thereby replacing the residual halogen atoms on the surfaces of the diamond powders with hydrogen atoms

11: A method for preparing hydrophobic diamond powders, comprising the steps of, in sequence,
i) reacting the diamond powders, whose non-carbon surface atoms have been desorbed, with a chemical agent that undergoes cycloaddition reactions with the diamond powders, thereby attaching hydrocarbon groups onto the surfaces of diamond powders through C—C bonds
ii) reacting the diamond powders with a halogen gas or a hydrogen halide gas, thereby adding hydrogen atoms and halogen atoms onto the surfaces of the diamond powders
iii) reacting the diamond powders with a reducing agent, thereby replacing the halogen atoms on the surfaces of the diamond powders with hydrogen atoms

12: A method for preparing negatively charged diamond powders, comprising the steps of, in sequence,
i) reacting halogenated diamond powders with a organometallic compound, thereby attaching hydrocarbon groups containing C—C double or triple bonds onto the surfaces of diamond powders through C—C bonds
ii) reacting the diamond powders with a basic aqueous solution, thereby replacing the halogen atoms on the diamond powders with hydroxyl groups
iii) reacting the diamond powders with a oxidizing agent, thereby transforming the C—C double or triple bonds into carboxylic groups. The carboxylic groups are attached on the surfaces of the diamond powders directly or attached on the surfaces of the diamond powders through the hydrocarbon groups
iv) reacting the diamond powders with a reducing agent, thereby transforming ketone structures into hydroxyl groups without reducing carboxylic acid groups

13: A method for preparing positively charged diamond powders, comprising the steps of, in sequence,
i) reacting the halogenated diamond powders with a aminating agent, thereby replacing some halogen atoms attached on the surfaces of the diamond powders directly or the halogen atoms attached on the hydrocarbon groups, which are attached on the surfaces of the diamond powders through C—C bonds, with amino groups
ii) reacting the diamond powders with a basic aqueous solution, thereby replacing the residual halogen atoms with hydroxyl groups
iii) reacting the diamond powders with a reducing agent, thereby transforming surface oxygen functionalities other than hydroxyl groups into hydroxyl groups
iv) reacting the diamond powders with a alkylating agent, thereby transforming the amino groups into quaternary amino groups
